(19) United States
(12) Patent Application Publication
(10) Pub. No.: US 2020/0223680 A1
(43) Pub. Date: Jul. 16, 2020

(54) Oil Change Funnel with Oil-Tight Rotating Member

(71) Applicant: Reynolds Shapiro, Inc., Salt Lake City, UT (US)

(72) Inventor: Zak Reynolds, West Valley City, UT (US)

(73) Assignee: Reynolds Shapiro, Inc., Salt Lake City, UT (US)

(21) Appl. No.: 16/246,081

(22) Filed: Jan. 11, 2019

(51) Int. Cl. B67C 11/02; B25B 27/00

(52) U.S. Cl. CPC B67C 11/02; B67C 2011/022; B25B 27/0042

(57) ABSTRACT

An oil draining apparatus comprises a funnel with two apertures. A first aperture comprises a compression fitting for creating an oil-tight seal around a socket wrench or socket wrench extension,but still allowing for rotation of the socket wrench or socket wrench extension in the first aperture and compression fitting. The compression fitting may be a non-metallic strain relief cord connector. The second aperture may comprise a spout for draining oil, or tubing for draining oil, or an adapter for tubing for draining oil. A method for draining oil comprises inserting a socket wrench extension through the compression fitting and rotating the socket wrench to loosen an oil plug on a vehicle, thereby discharging the oil. The funnel may comprise additional apertures with universal adapters.

### BACKGROUND OF THE INVENTION

Changing the oil on a car, vehicle, or other mechanical device often requires draining the used oil before adding new oil. In many instances, the used oil is drained by removing a threaded nut referred to as an oil plug. The oil plug is often located on or around the bottom of the oil pan or other reservoir for the oil. If not located directly on the bottom of the oil pan, the oil plug is may be located such that the oil drains by gravity when the oil plug is removed.

Oil plug removal can be messy. Often, the oil plug is configured for removal with a socket wrench, i.e., the oil plug is designed such that a socket head fits around the oil plug. A user may then use a socket wrench to rotate, and thereby loosen, the oil plug. Although using a socket wrench is effective for loosening and removing an oil plug, the oil discharge resulting from loosening and removing the oil plug gets on the wrench, the user's hand, and other undesirable places.

What is needed is an improved apparatus for decreasing or eliminating mess resulting from oil discharge when loosening and/or removing an oil plug.

### BRIEF SUMMARY OF THE INVENTION

An oil draining apparatus comprises a funnel with two apertures. A first aperture comprises a compression fitting for creating an oil-tight seal around a socket wrench or socket wrench extension, but still allowing for rotation of the socket wrench or socket wrench extension in the first aperture and compression fitting. The compression fitting may be a non-metallic strain relief cord connector. The second aperture may comprise a spout for draining oil, or tubing for draining oil, or an adapter for tubing for draining oil.

The funnel may comprise additional apertures with universal adapters,

A method for draining oil comprises inserting a socket wrench extension through the compression fitting and rotating the socket wrench to loosen an oil plug on a vehicle, thereby discharging the oil.

### BRIEF DESCRIPTION OF THE DRAWINGS

FIG. 1 shows a cross section of an exemplary funnel.

FIG. 2 shows a cross section of an exemplary funnel, as well as a barbed tubing adapter, a compression fitting, and a plug.

FIG. 3 shows a lower angle view of an exemplary funnel with universal adapters in the three apertures.

FIG. 4 shows a lower angle view of an exemplary funnel with universal adapters in the three apertures, and an exploded view of a barbed tubing adapter, a plug, and a compression fitting.

FIG. 5 shows a lower angle view of an exemplary funnel in which the barbed tubing adapter, compression fitting, and plug are engaged and secured.

FIG. 6 shows a lower angle view of an exemplary funnel, with a socket wrench extension inserted through an aperture and compression fitting to engage an oil plug.

FIG. 7 shows an exploded view of an exemplary compression fitting.

### DETAILED DESCRIPTION OF THE INVENTION

An improved funnel apparatus is disclosed for loosening and removing an oil plug and for routing oil discharge during and after loosening and removal of an oil plug.

Table of Reference Numbers from Drawings:

The following table is for convenience only and should not be construed to supersede any potentially inconsistent disclosure herein.

| Reference | |
|---|---|
| Number | Description |
| 100 | funnel |
| 110 | first aperture |
| 112 | threaded female adapter |
| 120 | second aperture |
| 122 | threaded female adapter |
| 130 | third aperture |
| 132 | threaded female adapter |
| 140 | spout |
| 150 | discharge tubing adapter |
| 160 | discharge tubing |
| 165 | plug |
| 170 | oil plug |
| 200 | compression fitting |
| 210 | male threaded receiver |
| 220 | female threaded receiver, or female threaded cap |
| 222 | ridge of female threaded receiver |
| 230 | conical seal |
| 240 | toothed compressible seal |
| 300 | socket wrench |
| 320 | socket wrench extension |
| 322 | socket head adapter on end of socket wrench extension |
| 324 | socket wrench adapter on end of socket wrench extension |
| 330 | socket head |

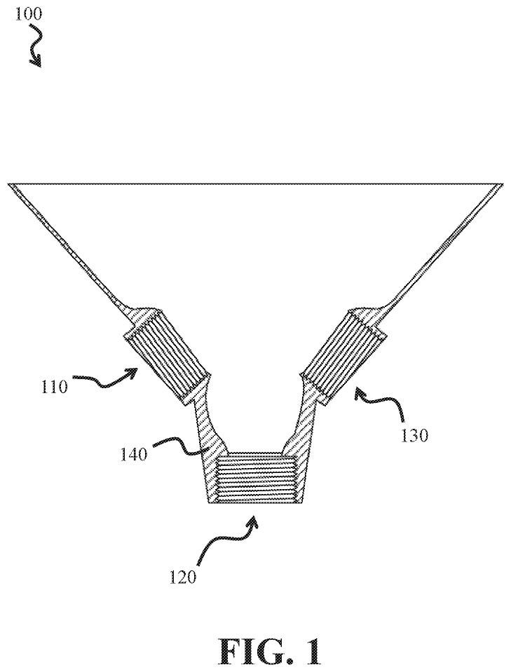

As shown in FIG. 1, in one embodiment, a funnel 100 may include, in addition to an open top, three apertures 110, 120, and 130. Aperture 120 may be a spout 140 that comprises an oil-tight wrench access. Aperture 110 may comprise an oil drain spout, or an adapter for an oil drain spout, and may further comprise an oil routing adapter or apparatus. Aperture 130 may comprise a plug, or an adapter for a plug, or a universal adapter so that various components may be secured to funnel 100 via aperture 130. In one embodiment, one or all of apertures 110, 120, and 130 may be configured for interchangeable components, e.g., with universal adapters, so that components secured to each aperture may be interchangeable.

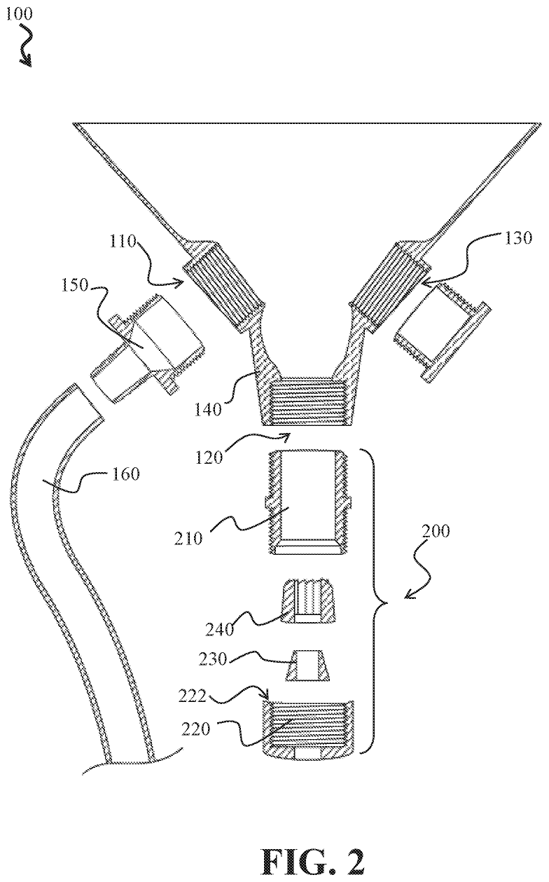

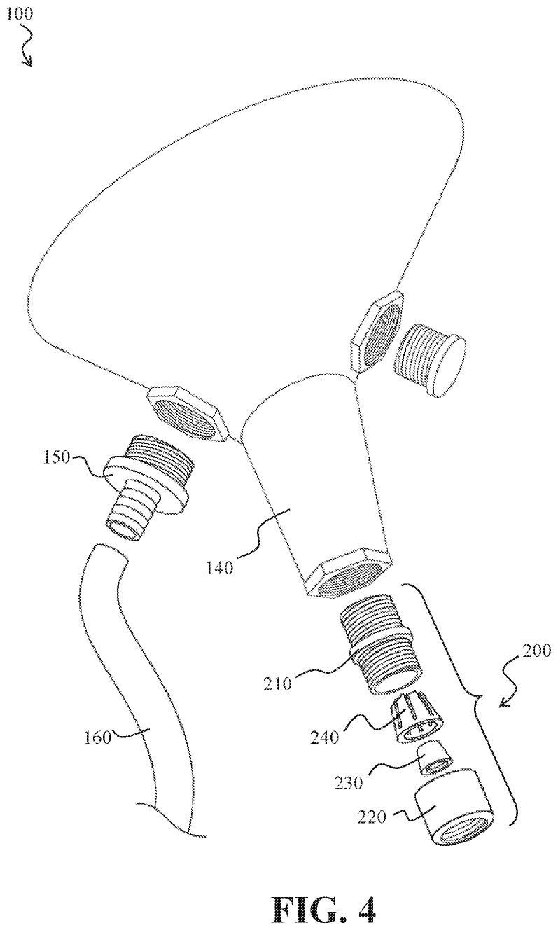

Aperture 120 may be for wrench access and may comprise an oil-tight seal through which a socket wrench extension, or socket wrench, or other rotating apparatus or may be inserted so that a user's hand may access the tool below, i.e., outside of the funnel, and a socket head or other rotating member may access the oil plug nut within, or above, the funnel. In one embodiment, the oil-tight seal may be a compression fitting 200 such as a non-metallic strain relief cord connector, e.g., a Halex ¾ in. ACC Non-Metallic Strain Relief Cord Connector or Similar compression fittings are manufactured and distributed by numerous companies and are available in multiple styles and sizes. As shown in FIGS. 2, 4, and 7, compression fitting 200 may comprise four parts: a male threaded receiver 210, a female threaded cap 220, a conical seal 230, and a toothed compressible seal 240. Toothed compressible seal 240 may comprise nylon fingers. Male threaded receiver 210 of compression fitting 200 may be manufactured as a. monolithic part of funnel 100 or may be secured or adhered to funnel 100.

Many compression fittings are known in the art and may possibly be used. The primary characteristics of a compression fitting suitable for a funnel in this applicationare that it must accept a tool, e.g., a shaft of a socket wrench extension, it must create an oil-tight (or substantially oil-tight) seal around the tool (e.g., shaft of socket wrench extension), and, even with the oil-tight seal, it must allow for the tool (e.g., shaft of socket wrench extension) to freely rotate within the compression fitting.

Compression fitting 200 satisfies these requirements. As shown in FIGS. 2, 4, and 7, female threaded cap 220 is tapered on the inner receiving portion to complement the shape of toothed compressible seal 240 and conical seal 230. In one embodiment, toothed compressible seal 240 may be made of a non-compressible (or substantially non-compressible) plastic or nylon, and may have panels topped with “teeth,” wherein the spaces between the panels collapse and compress when toothed compressible seal 240 is inserted and pressed into the tapered inner end of male threaded receiver 210.

Conical seal 230 may be made of a compressible rubber, plastic, or other material as known in the art, and, as shown in FIGS. 2, 4, and 7, may be shaped to track the inner shape and contours of toothed compressible seal 240, and to be complementary to the inner tapered end of male threaded receiver 210.

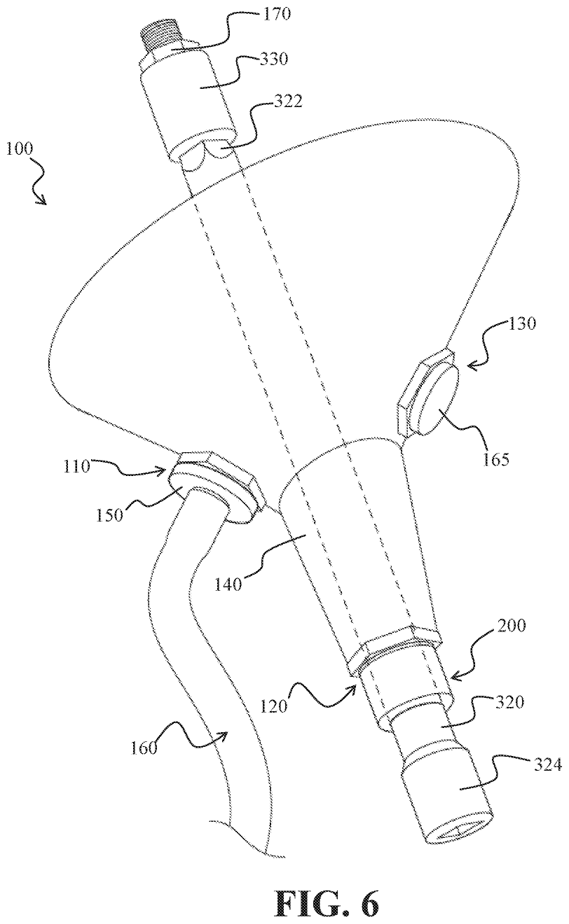

Ridge 222 of female threaded cap 220 is located, designed, sized, and shaped to engage the bottom end of toothed compressible seal 240 and conical seal 230 when female threaded cap 220 is threaded onto male threaded receiver 210, thereby pressing toothed compressible seal 240 and conical seal 230 into the complementary inner tapered end of male threaded receiver 210, compressing the panels of toothed compressible seal 240, and also compressing conical seal 230, thereby creating an oil-tight seal around a shaft of socket wrench extension. FIG. 6 shows compression fitting 200 compressed and sealed around socket wrench extension 320.

In another embodiment, a rotary shaft seal or a radial shaft seal may be used to create an oil-tight seal that allows for rotating a tool or adapter for a tool. Many rotary shaft seals and radial shaft seals are known in the art.

In one embodiment, male threaded receiver 210 may be secured to aperture 120 using an adhesive, e.g., plastic glue. Many adhesive, tape, or other options are known in the art.

Alternatively, male threaded receiver may be mechanically secured, e.g., using a clamp ring and/or a gasket, or any apparatus or means known in the art for creating an oil-tight seal around an object.

In one embodiment, male threaded receiver 210 may be secured to funnel 100 using plastic glue. As shown in FIG. 6, a socket wrench extension 320 may be inserted through compression fitting 200 so that socket wrench extension 320 is partially inside funnel 100 and partially outside funnel 100, i.e., so that the end 322 of socket wrench extension 320 with an adapter to receive a socket head 330 is inside funnel 100 and the end 324 of socket wrench extension 320 with a socket wrench adapter is outside, i.e., below, funnel 100.

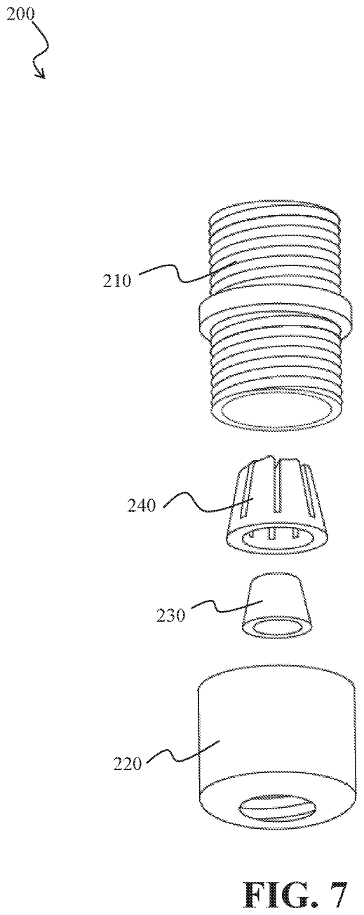

FIG. 7 shows a close-up view of a compression fitting 200, which may be non-metallic strain relief cord connector cord connector compression fitting used for electrical applications. Socket wrench extension 320 may be inserted through strain relief compression fitting 200 and strain relief compression fitting 200 may be secured onto male threaded receiver 210 by screwing female threaded cap 220 onto male threaded receiver 210—thereby compressing toothed compressible seal 240 and conical seal 230 and creating a seal around the shaft of socket wrench extension 320.

In one embodiment, socket wrench extension 320 has a circular cross section with a diameter of ⅜ inches, and the compression fitting size ¾ inches, which refers to the measurement of male threaded receiver 210. When the all parts of the compression fitting are engaged and tightened, the compression fitting will create a seal around the ⅜ inches diameter socket wrench extension 320.

Using compression fitting 200 as described herein to create a seal around socket wrench extension 320 results in an oil-tight seal, or at least a substantially oil-tight seal, but still allows for free rotation of socket wrench extension 320 within the sealed compression fitting.

In general, a socket wrench extension with any diameter may be used, and the size of the corresponding compression fitting may be changed or substituted to correspond to the size of diameter of the socket wrench extension. In another embodiment, the size of compression fitting and/or compression receiver piece may be changed based on the diameter of the socket wrench extension.

A part or tool other than a socket wrench extension may be used and inserted through the hole in the funnel and through the compression fitting. In general, any rotating piece that may be used to rotate the oil plug may be used. For example, a non-ratcheting tool, e.g., a screwdriver with an adapter for a socket head or other adapter for engaging and rotating the oil plug, may be used.

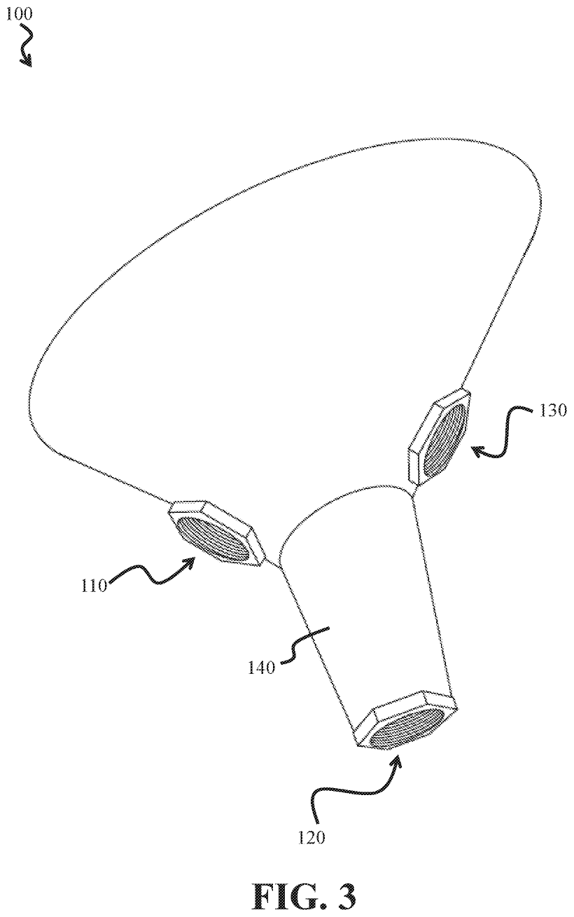

As shown in FIGS. 1-5, aperture 110 in funnel 100 may be used for draining and/or routing discharged oil. In one embodiment, aperture 110 may be a simple spout. As is known in the art, many characteristics of the spout may vary: length, tapering, diameter, curvature/straightness, rigidity, and other characteristics.

In one embodiment, as shown in FIGS. 2, 3, 5, and 6, aperture 110 may include discharge/routing tubing 160 and/or tubing adapter 150 for routing discharged oil to a drain pan or other apparatus, reservoir, container, or location in which it may be desirable to collect discharged oil or to which is may be desirable to route discharged oil.

Discharge/routing tubing 160 may be secured to funnel 100 in many different ways: Discharge/routing tubing 160 may be a monolithic part of funnel 100, or may be secured by a clamp, or may be glued or otherwise adhered, or, as shown in FIGS. 2, 3, and 5, may be secured via a pipe or tube fitting such as a barbed coupling, or in any other way know in the art for creating an oil-tight, or liquid-tight, or substantially oil-tight, or substantially liquid-tight connection with tubing.

In one embodiment, discharge routing/tubing 160 may additionally be secured to a discharge pan, catch or reservoir to ensure that the discharged oil will be routed into the discharge pan, catch or reservoir, and not expelled or discharged to an undesirable location, e.g., onto the ground.

In one embodiment, discharge/routing tubing 160 may be poly tubing with an inner diameter of 1.0 inches. Many different types, sizes, and dimensions of piping, tubing, conduit, or other routing means may be used. Larger tubing, e.g., tubing having a greater diameter, may be useful for more quickly routing and draining oil out of funnel 100, but may be more difficult to bend, curve, maneuver, and/or transport. Smaller tubing, e.g., tubing having a smaller diameter, may not drain or route discharged oil as quickly as larger tubing, but may be easier to bend, curve, maneuver, and/or transport. Discharge/routing tubing may have a varying length, and may also include extensions.

As shown in FIG. 6, with a socket wrench extension 320 inserted through aperture 120, and with compression fitting 200 tightened and secured around socket wrench extension 320, a socket wrench 200 may engage extension 320, and the opposing end 322 of extension 320 may engage a socket 330, which may engage oil plug 170. Additionally, as shown in FIGS. 2, 3, and 5, discharge/routing tubing 160 may be secured to aperture 110, and may be routed so that discharged oil is routed into a desired collection area, apparatus, or container.

When user rotates socket wrench 300 in a direction that loosens oil plug 170, oil will begin to discharge from the vehicle's oil reservoir into funnel 100, and will be discharged/drained through aperture 100 and through discharge/routing tubing 160. Because the seal around wrench extension 320 is oil-tight, discharged oil does not leak or otherwise pass compression fitting 200, but is instead drained out discharge/routing tubing 160. In this manner, discharged oil does not get on a user's hands, on the socket wrench, or in other undesirable locations.

Many different shapes of funnels may be used depending on particular applications: angle of oil plug, accessibility of drain plug, or other features of a particular application. For example, apertures 110, 120, and 130 may be located in different positions on funnel 100, thereby allowing for use of funnel 100 at different angles and/or orientations. Also, many different shapes of funnel may be used depending on characteristics of particular applications.

Funnel 100 may be made out of plastic, metal, rubber, composite materials, fiberglass, or any other materials known in the art. In one embodiment, funnel 100 may be made out of plastic.

In one embodiment, the upper rim of funnel 100 may include magnets, which may be embedded or otherwise secured to funnel, and which may allow funnel 100 to be secured to a vehicle's oil pan or other metallic surface so that the funnel remains in place without the use of a hand or other solution for keeping the funnel in place while discharging oil.

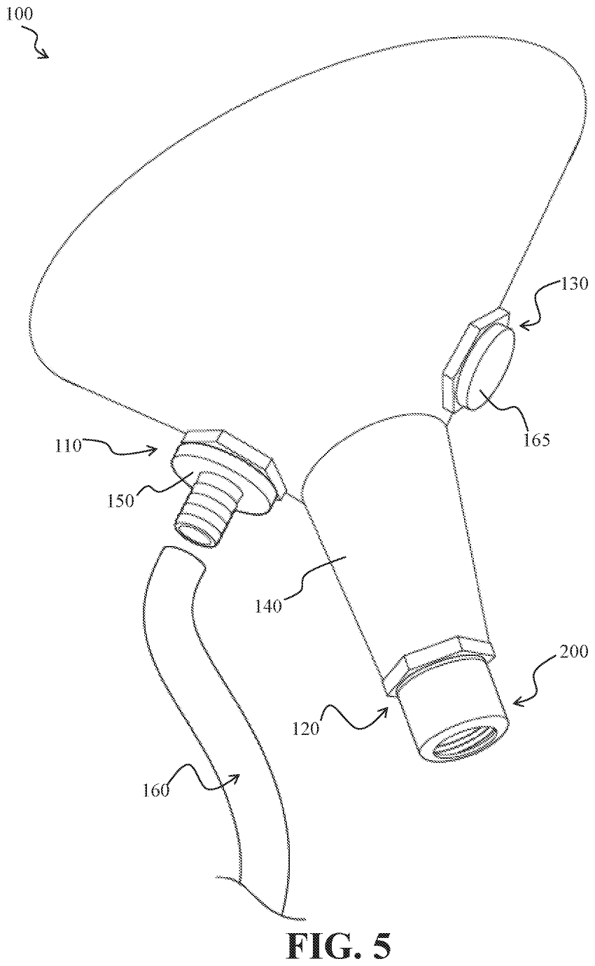

In one embodiment, as shown in FIGS. 1-5, compression fitting 200 and discharge/routing tubing 160 may be interchangeable. For example, as shown in FIG. 5, funnel 100 may comprise three apertures 110, 120, and 130, and each aperture may respectively comprise a threaded female adapter 112, 122, and 132 sized to receive a threaded male adapter 150 for discharge routing tubing (e.g., a barbed connector), or a threaded male adapter 210 for a compression fitting, or a threaded male plug 165—where the threaded male adapter 150 for discharge routing, the threaded male adapter 210 for a compression fitting, and the threaded male plug 165 have the same threading pattern and dimensions to fit into the threaded female adapters 112, 122, and 132. In this manner, compression fitting 200, discharge/routing tubing adapter 150, and plug 165 may be interchanged and switched among the three apertures 110, 120, and 130. This is useful for changing the angles and/or orientation of funnel 100 based on varying characteristics of particular oil discharge applications, situations, and/or circumstances. In this manner, the three apertures 110, 120, and 130 may be universal, allowing for interchangeability of discharge tubing adapter 150, compression fitting 200, and plug 165.

Because the holes and fittings are universal, the discharge/routing tubing and compression fitting may be moved to different locations on funnel [rf], thereby allowing for adaptability and reconfigurability based on characteristics of different applications: accessibility of oil plug, angle of oil plug, interfering vehicle parts or other obstructions, features of tools such as socket wrench or socket wrench extension, or other characteristics of different applications that may make re-orienting or re-positioning or re-locating routing-discharge tubing and compression fitting desirable to increase comfort, accessibility, convenience, or other factors.

More than three apertures could be used in a universal application. Three apertures will, however, generally be sufficient to facilitate a good configuration for most applications.

The apparatus disclosed herein may be used for liquids other than automotive oil, and in other applications other than for oil changes and/or draining oil.

What is claimed is:

1. An apparatus, comprising:
a funnel comprising an open top, a first aperture, and a second aperture;
wherein:
the first aperture comprises an oil-tight fitting configured to seal around a rotating member.

2. The apparatus of claim 1, wherein the second aperture comprises an oil discharge adapter.

3. The apparatus of claim 1, wherein the oil-tight fitting is a compression fitting.

4. The apparatus of claim 3, wherein the compression fitting is a strain relief cord connector comprising a female threaded receiver, a conical seal, a toothed compressible seal, and a male threaded receiver.

5. The apparatus of claim 1, wherein the oil-tight fitting is a rotary shaft seal or a radial shaft seal.

6. The apparatus of claim 2, wherein the oil discharge adapter is a tapered spout.

7. The apparatus of claim 2, wherein the oil discharge adapter is tubing.

8. The apparatus of claim 2, wherein the oil discharge adapter is a tubing adapter.

9. The apparatus of claim 8, wherein the tubing adapter is a barbed fitting for tubing.

10. The apparatus of claim 1, wherein the first aperture and the second aperture each comprise a respective universal adapter.

11. The apparatus of claim 1, wherein:
the funnel further comprises a third aperture; and
the third aperture comprises a universal adapter.

12. A method, comprising:
engaging an oil plug with a rotating tool inserted through a first aperture in a funnel;
rotating the rotating tool to loosen the oil plug and discharge oil;
wherein:
the funnel comprises an open top, the first aperture, and a second aperture; and
the first aperture comprises an oil-tight fitting configured to seal around a rotating member.

13. The method of claim 13, wherein the rotating tool is a socket wrench or socket wrench extension.

14. The method of claim 12, wherein the second aperture comprises an oil discharge adapter.

15. The method of claim 12, wherein the oil-tight fitting is a compression fitting.

16. The method of claim 15, wherein the compression fitting is a strain relief cord connector comprising a female threaded receiver, a conical seal, a toothed compressible seal, and a male threaded receiver.

17. The method of claim 12, wherein the oil-tight fitting is a rotary shaft seal or a radial shaft seal.

18. The method of claim 14, wherein the oil discharge adapter is a tapered spout, tubing, or a tubing adapter, or a barbed fitting for tubing.

19. The method of claim 12, wherein the first aperture and the second aperture each comprise a respective universal adapter.

20. The method of claim 12, wherein:
the funnel further comprises a third aperture;
the third aperture comprises a universal adapter.
